(19) United States
(12) Patent Application Publication
(10) Pub. No.: US 2015/0261602 A1
(43) Pub. Date: Sep. 17, 2015

(54) RESISTANCE CHANGE MEMORY

(71) Applicant: Katsuyuki FUJITA, Seoul (KR)

(72) Inventor: Katsuyuki FUJITA, Seoul (KR)

(21) Appl. No.: 14/482,968

(22) Filed: Sep. 10, 2014

Related U.S. Application Data
(60) Provisional application No. 61/952,686, filed on Mar. 13, 2014.

(51) Int. Cl. G06F 11/10

(52) U.S. Cl. CPC G06F 11/1008

(57) ABSTRACT

According to one embodiment, a resistance change memory comprises a memory cell array, an error checking and correcting (ECC) circuit and a controller. The memory cell array comprises memory cells including magnetic tunnel junction (MTJ) elements. The error checking and correcting (ECC) circuit performs an ECC operation to detect an error in data read from the memory cells and correct the error. The controller performs the ECC operation by the ECC circuit at a predetermined period.

### CROSS-REFERENCE TO RELATED APPLICATIONS

This application claims the benefit of U.S. Provisional Application No. 61/952,686, filed Mar. 13, 2014, the entire contents of which are incorporated herein by reference.

### FIELD

Embodiments described herein relate generally to a resistance change memory to store data by using the change of the resistance value of a memory element.

### BACKGROUND

Recently, attention has been focused on semiconductor memories that use, as a memory device, a nonvolatile memory such as a resistance change memory (e.g., a magnetoresistive random access memory: MRAM, a phase change random access memory: PRAM, or a resistive random access memory: ReRAM).

In the resistance change memory, the change of its resistance value caused by the application of a current (or voltage) is used to determine whether data is “1” or “0”.

### BRIEF DESCRIPTION OF THE DRAWING

FIG. 1 is a diagram showing the configuration of an MRAM according to an embodiment;

FIGS. 2 and 3 are diagrams showing the detailed configuration of the MRAM according to the embodiment;

FIG. 4 is a block diagram of a memory cell array according to the embodiment;

FIG. 5 is a circuit diagram of one group GP included in the memory cell array according to the embodiment;

FIG. 6 is a sectional view of an MTJ element according to the embodiment;

FIG. 7 is a circuit diagram of a temperature sensor according to the embodiment;

FIG. 8 is a graph showing the current characteristics of the temperature sensor according to the embodiment;

FIG. 9 is a flowchart showing an ECC operation in the MRAM according to the embodiment; and

FIG. 10 is a diagram showing the ECC operation for a multibank in the MRAM according to the embodiment.

### DETAILED DESCRIPTION

Hereinafter, a resistance change memory according to an embodiment will be described with reference to the drawings. In the following description, the same reference signs are provided to components having the same functions and configurations, and repeated explanations are given only when necessary. Embodiments shown below illustrate devices and methods which embody the technical concepts of the embodiments, and the materials, shapes, structures, and locations of the components are not limited to those specified as below.

In general, according to one embodiment, a resistance change memory comprises a memory cell array, an error checking and correcting (ECC) circuit and a controller. The memory cell array comprises memory cells including magnetic tunnel junction (MTJ) elements. The error checking and correcting (ECC) circuit performs an ECC operation to detect an error in data read from the memory cells and correct the error. The controller performs the ECC operation by the ECC circuit at a predetermined period.

An MRAM is described as an example of the resistance change memory in the embodiment below.

### [1] CONFIGURATION OF MRAM

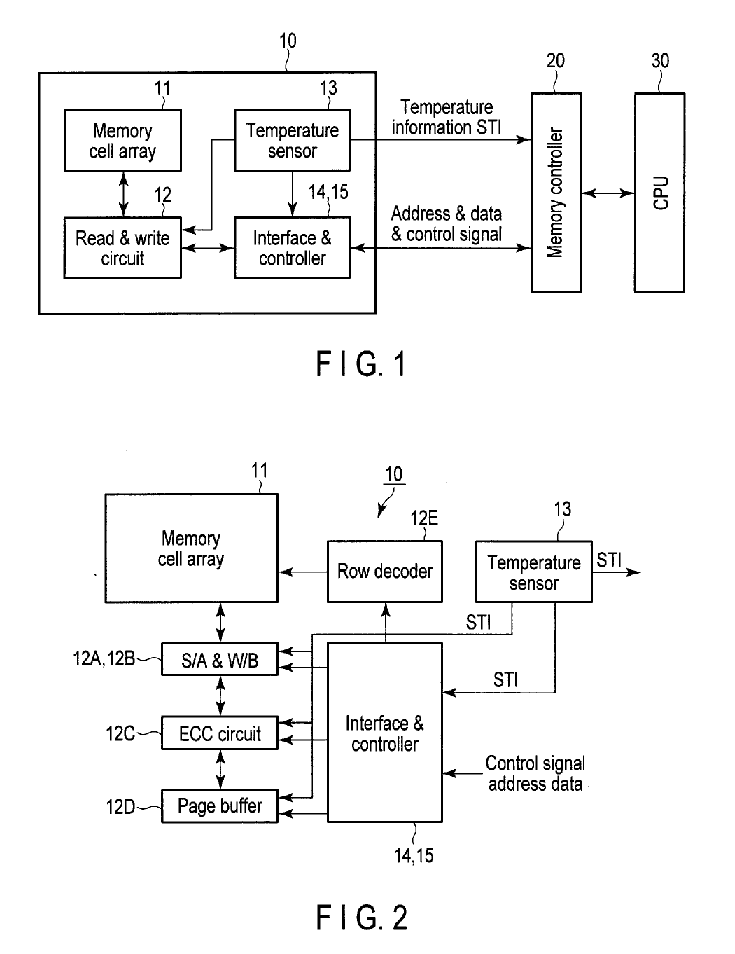

FIG. 1 is a diagram showing the configuration of the MRAM according to the embodiment.

According to the present embodiment, an MRAM 10 and a memory controller 20 are provided. The MRAM 10 includes a memory cell array 11, a read/write circuit 12, temperature sensor 13, an interface 14, and a controller 15. The MRAM 10 can store data in memory cells disposed in the memory cell array 11. The memory controller 20 controls the operation of the MRAM 10. A CPU 30 may be further connected to the memory controller 20 as an external system. The CPU 30 sends signals to the memory controller 20 and receives signals from the memory controller 20.

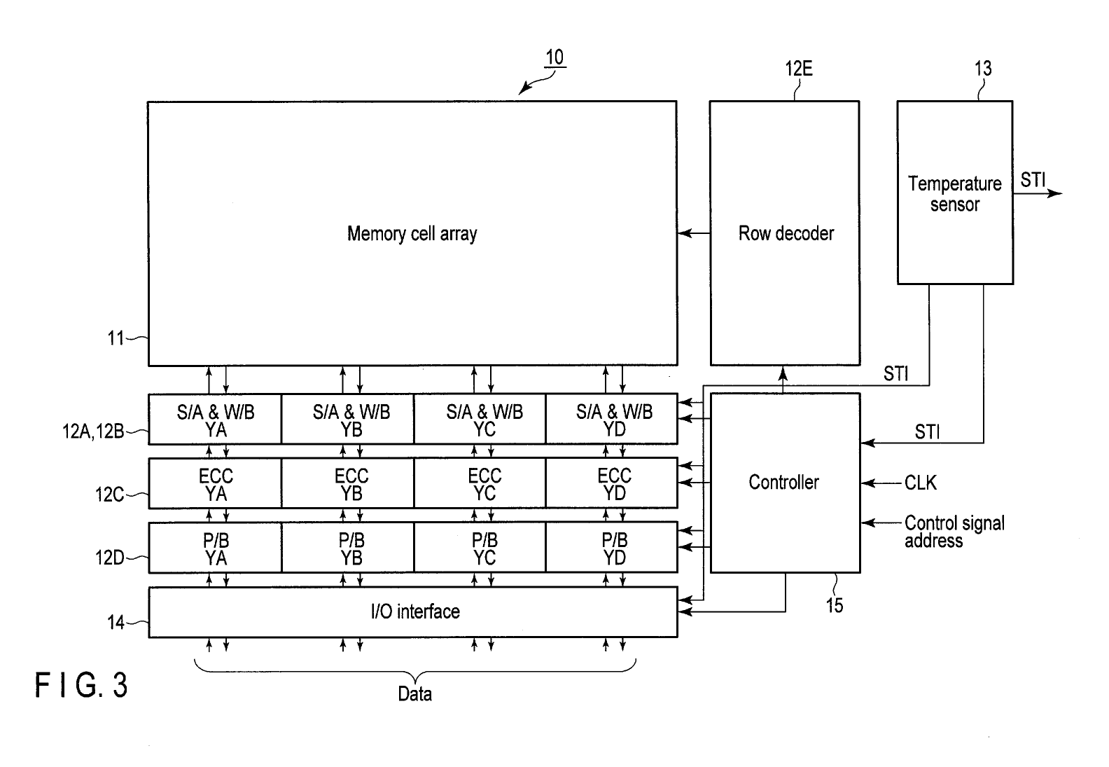

The detailed configuration of the MRAM according to the embodiment is shown in FIGS. 2 and 3.

The memory cell array 11 includes the memory cells. Here, the memory cells have magnetoresistive effect elements, for example, magnetic tunnel junction (MTJ) elements as resistance change elements. The configuration of the memory cells will be described in detail later.

The read/write circuit 12 comprises a sense amplifier (S/A) 12A, a write buffer (W/B) 12B, an error checking and correcting (ECC) circuit 12C, a page buffer (P/B) 12D, and a row decoder 12E.

[1-1] Configuration of Memory Cell Array

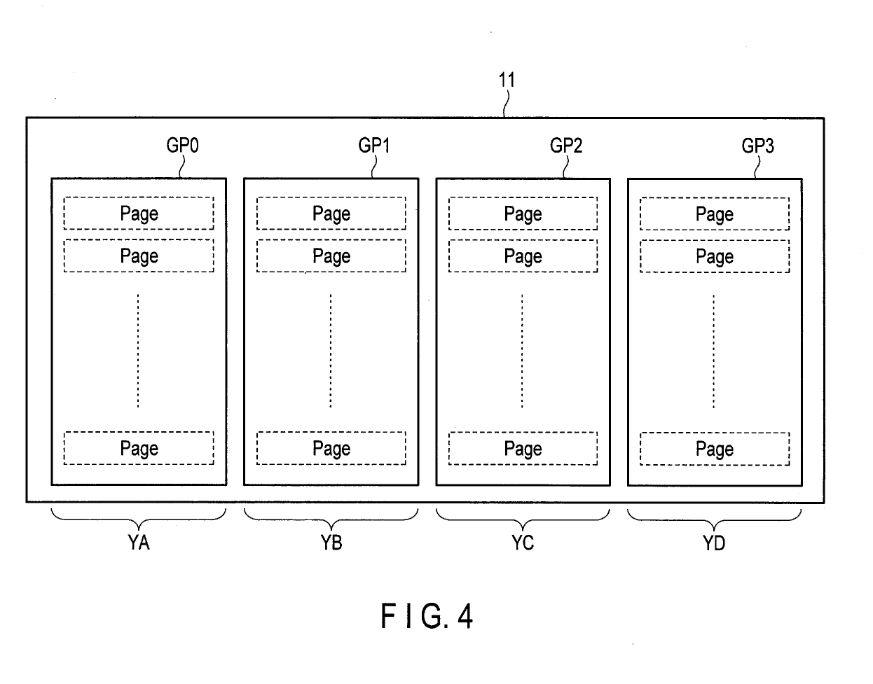

FIG. 4 is a block diagram of the memory cell array 11. The memory cell array 11 comprises groups GP. In FIG. 4, four groups GP0 to GP3 are shown by way of example. Each group GP is a unit for independently performing a data write operation and a data read operation (interleave processing and parallel processing). While the interleave processing is performed by four columns, YA, YB, YC, and YD, corresponding to the four groups GP0 to GP3 in the following explanation by way of example, the number of groups GP (number of columns) can be designed to be any number. Each group GP comprises pages.

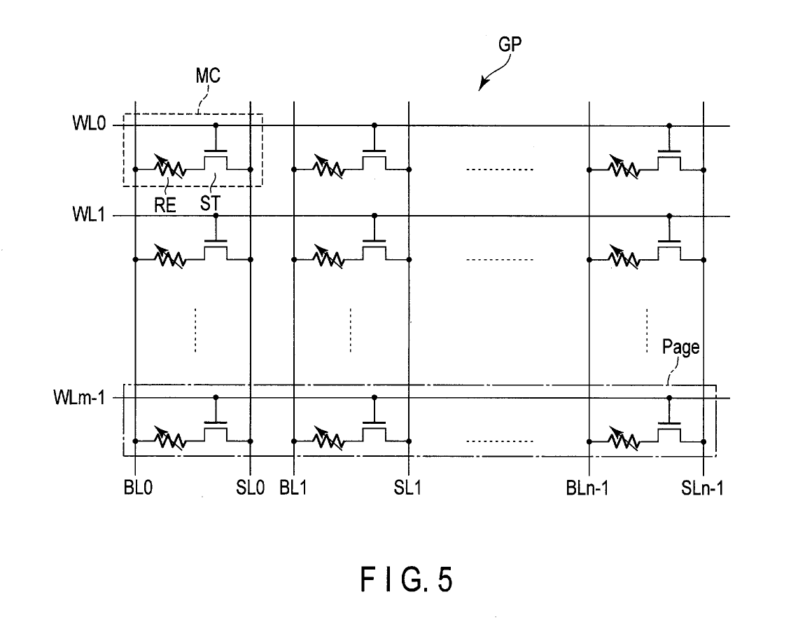

FIG. 5 is a circuit diagram of one group GP included in the memory cell array 11. The group GP includes memory cells MC arrayed in a matrix form. Word lines WL0 to WLm−1, bit lines BL0 to BLn−1, and source lines SL0 to SLn−1 are arranged in the group GP. A memory cell group for one row of groups GP, that is, for one page is connected to one word line WL. One column of groups GP is connected to a pair comprising one bit line BL and one source line SL. The common word lines WL0 to WLm−1 are connected to the groups GP0 to GP3. m and n are natural numbers equal to or more than 1.

The memory cell MC comprises, for example, a magnetic tunnel junction (MTJ) element RE and a select transistor ST. The select transistor ST comprises, for example, an re-channel MOS field effect transistor.

One end of the MTJ element RE is connected to the bit line BL, and the other end of the MTJ element RE is connected to the drain of the select transistor ST. The source of the select transistor ST is connected to the source line SL. Moreover, the gate of the select transistor ST is connected to the word line WL.

[1-2] Structure of MTJ Element

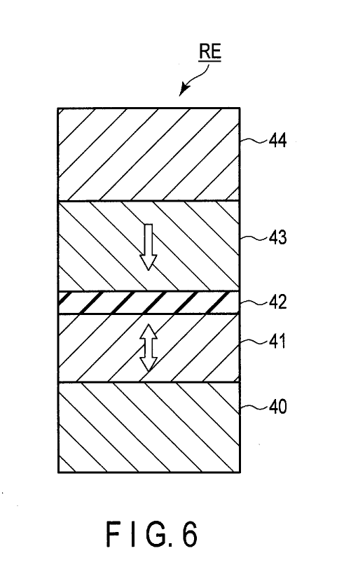

Now, one example of the structure of the MTJ element RE is described. FIG. 6 is a sectional view of the MTJ element RE. The MTJ element RE comprises a bottom electrode 40, a storage layer (also referred to as a free layer) 41, a nonmagnetic layer (tunnel barrier layer) 42, a reference layer (also referred to as a fixed layer) 43, and a top electrode 44 that are stacked in the order above. The storage layer 41 and the reference layer 43 may be stacked in reverse order.

The storage layer 41 and the reference layer 43 are each made of a ferromagnetic material. An insulating material such as MgO is used as the tunnel barrier layer 42.

The storage layer 41 and the reference layer 43 each have perpendicular magnetic anisotropy, and their directions of easy magnetization are perpendicular directions. The magnetization directions of the storage layer 41 and the reference layer 43 may be in-plane directions.

The magnetization direction of the storage layer 41 is variable (inverted). The magnetization direction of the reference layer 43 is invariable (fixed). The reference layer 43 is set to have sufficiently higher perpendicular magnetic anisotropic energy than the storage layer 41. The magnetic anisotropy can be set by adjusting the material constitution and thickness. Thus, a magnetization inversion current for the storage layer 41 is lower, and a magnetization inversion current for the reference layer 43 is higher than that for the storage layer 41. As a result, it is possible to obtain an MTJ element RE that comprises the storage layer 41 variable in magnetization direction and the reference layer 43 invariable in magnetization direction for a predetermined write current.

According to the present embodiment, a spin-transfer torque writing method is used so that a write current is directly passed through the MTJ element RE, and the magnetization state of the MTJ element RE is controlled by this write current. The MTJ element RE can take one of a low-resistance state and a high-resistance state depending on whether the magnetizations of the storage layer 41 and the reference layer 43 are parallel or antiparallel.

If a write current running from the storage layer 41 to the reference layer 43 is passed through the MTJ element RE, the magnetizations of the storage layer 41 and the reference layer 43 are parallel. In this parallel state, the resistance value of the MTJ element RE is lowest, and the MTJ element RE is set to the low-resistance state. The low-resistance state of the MTJ element RE is determined as, for example, data “0”.

On the other hand, if a write current running from the reference layer 43 to the storage layer 41 is passed through the MTJ element RE, the magnetizations of the storage layer 41 and the reference layer 43 are antiparallel. In this antiparallel state, the resistance value of the MTJ element RE is highest, and the MTJ element RE is set to the high-resistance state. The high-resistance state of the MTJ element RE is determined as, for example, data “1”.

Consequently, the MTJ element RE can be used as a storage element capable of storing one-bit data (binary data). Any resistance state of the MTJ element RE and any allocation of data can be set.

When data is read from the MTJ element RE, a read voltage is applied to the MTJ element RE, and the resistance value of the MTJ element RE is detected in accordance with a read current running through the MTJ element RE at the moment. This read voltage is set to a value sufficiently lower than a threshold at which the magnetization is inverted by spin injection.

[1-3] Configuration of Read/Write Circuit

In FIG. 3, the sense amplifier 12A, the write buffer 12B, the ECC circuit 12C, and the page buffer 12D are provided for each of the columns YA, YB, YC, and YD. In the following explanation, when the sense amplifier 12A, the write buffer 12B, the ECC circuit 12C, and the page buffer 12D are mentioned in this way, this means that the columns YA to YD have a common configuration. On the other hand, the reference signs YA to YD are given only when the columns YA to YD need to be distinguished from one another.

The row decoder 12E is connected to the word lines WL0 to WLm−1. The row decoder 12E selects one of the word lines WL in accordance with a row address.

The sense amplifier 12A is connected to the bit lines BL0 to BLn−1. The sense amplifier 12A of, for example, a current detecting type compares a cell current running through the selected memory cell via the bit line BL with a reference current, and thereby detects and amplifies the data in the selected memory cell. During reading, the source lines are clamped to a ground voltage VSS by the write buffer 12B. An output from the write buffer 12B to the bit line is set to a Hi-Z state (high impedance state) to avoid conflict with the operation of the sense amplifier.

The write buffer 12B is connected to the bit lines BL0 to BLn−1 and the source lines SL0 to SLn−1. The write buffer 12B writes data into the selected memory cell via the bit line BL and the source line SL.

The ECC circuit 12C performs the ECC operation to detect an error in the read data and correct the error. That is, when data is written into the memory cell array 11, the ECC circuit 12C uses write data to generate an error correcting code, and adds this error correcting code to the write data. The error correcting code is written into a parity bit area in the memory cell array 11. When data is read from the memory cell array 11, the ECC circuit 12C uses the error correcting code read from the parity bit area to detect and correct an error. The error correcting code does not need to be read to the outside, and is therefore not read into the page buffer 12D. For such processing, the ECC circuit 12C comprises an ECC encoder and an ECC decoder.

The page buffer 12D holds the read data sent from the ECC circuit 12C. The page buffer 12D also holds the write data sent from the input/output interface circuit 14. The page buffer 12D comprises a read page buffer for holding read data, and a write page buffer for holding write data.

[1-4] Configurations of Interface and Controller

The input/output interface circuit 14 is connected to an external system, and inputs/outputs data to/from the external system. The input/output interface circuit 14 sends input data input from the external system to the page buffer 12D as write data. The input/output interface circuit 14 also outputs the read data received from the page buffer 12D to the external system as output data.

The controller 15 has overall control of the operations of the sense amplifier 12A, the write buffer 12B, the ECC circuit 12C, the page buffer 12D, the row decoder 12E, and the interface 14. The controller 15 receives an address (including a row address and a column address), and control signals such as a clock CLK and a command from the memory controller 20. The controller 15 supplies various control signals and various voltages to the sense amplifier 12A, the write buffer 12B, the ECC circuit 12C, the page buffer 12D, the row decoder 12E, and the interface 14, and thereby controls the operations of these circuits.

[1-5] Configuration of Temperature Sensor

The temperature sensor 13 is disposed in the vicinity of the memory cell array 11, and detects the temperature of the environment of the memory cell array 11, and then outputs temperature information STI corresponding to the detected temperature. The memory controller 20 receives the temperature information STI from the temperature sensor 13, and outputs a control signal for controlling the ECC operation in the MRAM 10 to the controller 15 in accordance with the temperature information STI. The controller 15 receives the control signal from the memory controller 20, and changes the period to perform the ECC operation in accordance with the control signal.

The ECC operation is periodically performed here at every predetermined time for all the memory cells in the memory cell array. The memory controller 20 adjusts the predetermined time via the controller 15. That is, the memory controller 20 adjusts the operating intervals at which the ECC operation is performed in accordance with the temperature information STI.

A detailed description is given below. When receiving temperature information STI1 (first information) indicating a high temperature from the temperature sensor 13, the memory controller 20 sets the period for performing the ECC operation to a short first period. When receiving temperature information STI2 (second information) indicating a medium temperature lower than the high temperature, the memory controller 20 sets the period for performing the ECC operation to a second period longer than the first period. When receiving temperature information STI3 (third information) indicating a low temperature lower than the medium temperature, the memory controller 20 stops the performance of the ECC operation. When receiving the temperature information STI3, the memory controller 20 may set the period for performing the ECC operation to a third period longer than the second period without stopping the performance of the ECC operation. As described above, the temperatures detected by the temperature sensor 13 are the high temperature>the medium temperature>the low temperature.

The temperature information STI output from the temperature sensor 13 is also input to the sense amplifier 12A, the write buffer 12B, the ECC circuit 12C, the page buffer 12D, the interface 14, and the controller 15. In response to the temperature information STI, the sense amplifier 12A, the write buffer 12B, the ECC circuit 12C, the page buffer 12D, the interface 14, and the controller 15 perform necessary operations in accordance with the temperature information STI. For example, in accordance with the temperature information STI, the ECC circuit 12C previously performs a switch operation which occurs depending on whether the ECC operation is performed. Depending on whether the ECC operation is performed, it is necessary to change the timing for transferring the read data to the sense amplifier 12A, the ECC circuit 12C, the page buffer 12D, and the interface 14. Thus, the temperature information STI is also transmitted to the controller 15 so that the controller 15 controls the timing for transferring the read data in accordance with the temperature information STI.

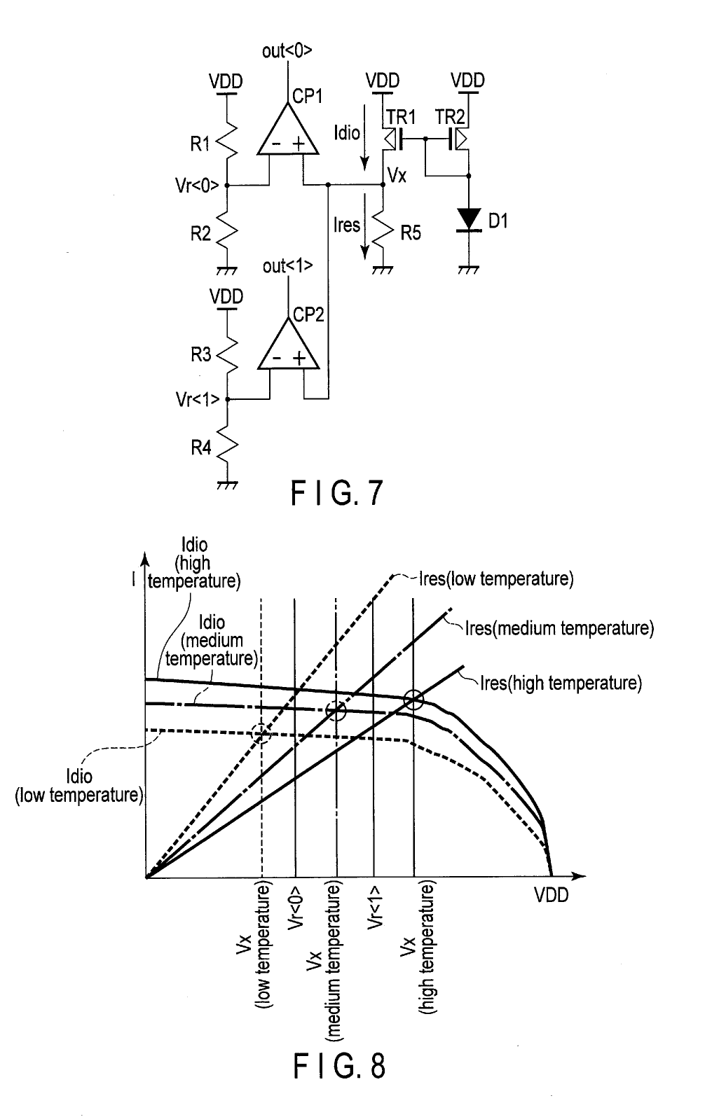

Now, one example of the configuration of the temperature sensor 13 is described. FIG. 7 is a circuit diagram of the temperature sensor 13 according to the embodiment. FIG. 8 is a graph showing the voltage-current characteristics of the temperature sensor 13.

As shown in FIG. 7, the temperature sensor 13 comprises comparators CP1 and CP2, resistances R1, R2, R3, R4, and R5, p-channel MOS field effect transistors TR1 and TR2, and a diode D1. A current running through the resistance R5 is Ires, and a current running through the diode D1 is Idio.

FIG. 8 shows the current characteristics of the current Ires and the current Idio in temperature conditions: the low temperature, the medium temperature, and the high temperature. This graph shows the level relationship between voltages Vx, Vr<0>, and Vr<1> in each temperature condition. This level relation can be easily obtained by adjusting the resistance ratio of R1, R2, R3, and R4 so that Vr<0>=R2*VDD/(R1+R2)<Vr<1>=R3*VDD/(R3+R4).

When the memory cell array 11 is in a low-temperature state, the voltage Vx is lower than the voltages Vr<0> and Vr<1> in FIG. 7. As a result, both outputs out<1> and out<0> become “low (L)”. Therefore, when detecting that the memory cell array 11 is in the low-temperature state, the temperature sensor 13 outputs “LL” as the temperature information STI.

When the memory cell array 11 is in the medium-temperature state, the voltage Vx is higher than the voltage Vr<0> and lower than Vr<1> in FIG. 7. As a result, the output out<1> becomes “low (L)”, and the output out<0> becomes “high (H)”. Therefore, when detecting that the memory cell array 11 is in the medium-temperature state, the temperature sensor 13 outputs “LH” as the temperature information STI.

When the memory cell array 11 is in the high-temperature state, the voltage Vx is higher than the voltages Vr<0> and Vr<1> in FIG. 7. As a result, both the outputs out<1> and out<0> become “high (H)”. Therefore, when detecting that the memory cell array 11 is in the high-temperature state, the temperature sensor 13 outputs “HH” as the temperature information STI.

In response to “LL”, “LH”, or “HH” as the temperature information STI from the temperature sensor 13, the memory controller 20 controls the period (or time interval) to perform the ECC operation in accordance with “LL”, “LH”, or “HH”.

Although the temperature sensor 13 detects three temperature ranges including the low temperature, the medium temperature, and the high temperature in the example shown here, the temperature sensor 13 may detect two temperature ranges including the low temperature and the high temperature, or may detect four or more temperature ranges. In this case, the circuits can be configured by eliminating or adding the comparators, the resistances, and condensers. Moreover, the temperature sensor 13 only uses standard components in a semiconductor circuit, and therefore has an advantage of being easily formable.

### [2] SEQUENCE OF ECC OPERATION

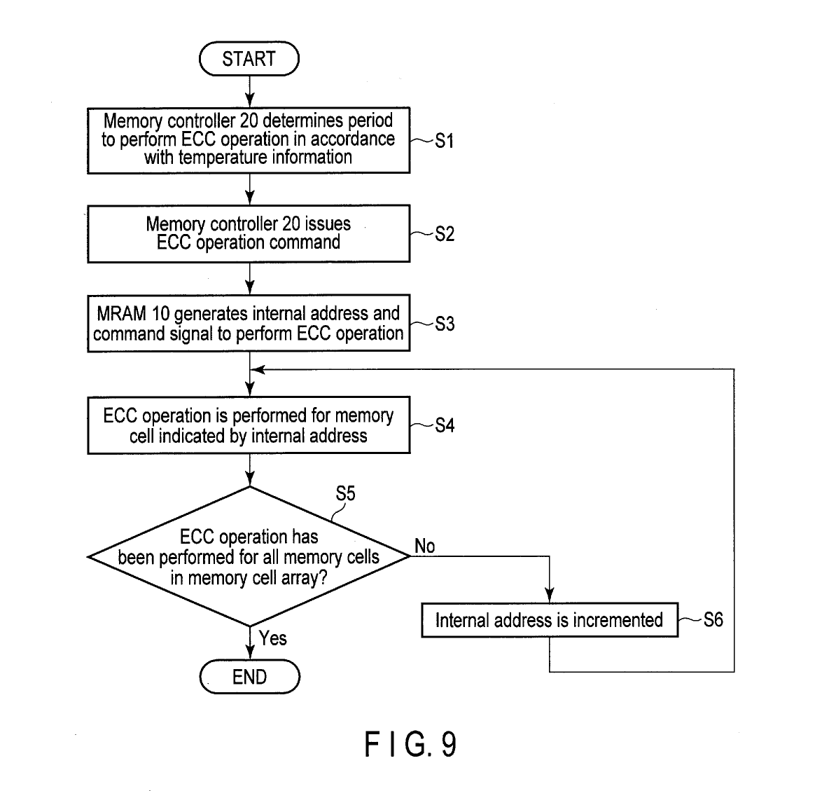

FIG. 9 is a sequence diagram showing the ECC operation according to the embodiment.

First, the memory controller 20 determines the period to perform the ECC operation in accordance with temperature information from the temperature sensor 13 (step S1). The memory controller 20 then issues an ECC operation command (step S2).

The controller 15 in the MRAM 10 then generates an internal address and a command signal to perform the ECC operation (step S3). Data is then read from the memory cell MC indicated by the internal address, and the ECC operation is performed for the read data (step S4). That is, the ECC operation is performed to detect an error in the read data and correct the error. Further, the corrected data after the ECC operation is written back to the memory cell array 11.

Whether the ECC operation has been performed for all the memory cells MC in the memory cell array 11 is then judged (step S5). When the ECC operation has been performed for all the memory cells, the ECC operation is finished.

On the other hand, when the ECC operation has not been performed for all the memory cells, the internal address is incremented (step S6). Back to step S4, the operations in and after step S4 are then repeated. When the ECC operation has then been performed for all the memory cells, the ECC operation is finished.

The ECC operation according to the present embodiment can be performed for more than one bank (multibank) in parallel instead of being performed for each bank.

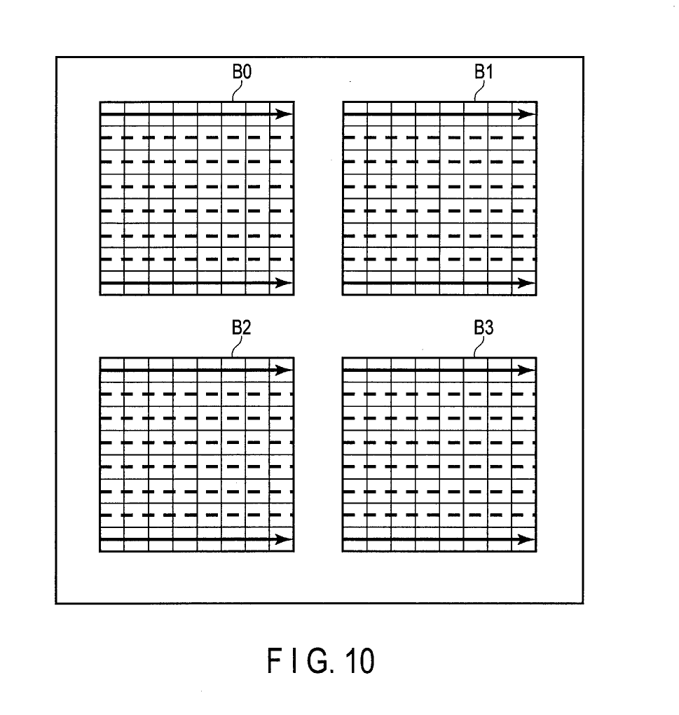

FIG. 10 is a diagram showing the ECC operation for the multibank according to the embodiment.

When there are banks B0, B1, B2, and B3 in the MRAM 10 as shown in FIG. 10, the ECC operation is simultaneously performed for the four banks B0, B1, B2, and B3 in parallel. The bank is a minimum unit including memory cells that are simultaneously accessible in parallel in response to an external read request or write request.

In a normal read operation, the banks are sequentially activated for reading; for example, the bank B0 is activated for reading, and then the bank B1 is activated for reading. According to the present embodiment, it is not necessary to output the read data to the external system, so that the ECC operation can be simultaneously performed for more than one bank in parallel. Consequently, the time necessary for the ECC operation in the MRAM 10 can be reduced.

Although the ECC operation is simultaneously performed for the four banks in parallel in the example shown here, it should be appreciated that the ECC operation according to the present embodiment can be simultaneously performed for two or three banks or for five or more banks in parallel.

### [3] ADVANTAGEOUS EFFECTS

For example, in the memory cell including the MTJ element in the MRAM, an error tends to occur in the data stored in the memory cell when the memory cell is in the high-temperature state. On the other hand, when the memory cell is in the medium-temperature state lower than the high-temperature state, a data error is less likely to occur at a higher temperature. When the memory cell is in the low-temperature state lower than the medium-temperature state, a data error hardly occurs.

Under these circumstances, according to the present embodiment, the ECC operation is periodically performed at every predetermined time for the memory cell including the resistance change element (e.g., the MTJ element) in the memory cell array. Thus, it is possible to correct, at every predetermined time, an error which has occurred in the memory cell, and prevent a failure from being caused by increased errors.

Furthermore, the temperature sensor is provided to detect the temperature of the memory cell in the memory cell array, and the predetermined time (period) for performing the ECC operation is changed in accordance with the temperature information detected by the temperature sensor. Thus, it is possible to perform the ECC operation for the memory cells in the memory cell array at a proper frequency, and prevent the normal read operation and write operation from being disturbed by the ECC operation.

Although the MRAM that uses the magnetoresistive effect element has been described as the resistance change memory by way of example in the above embodiments, the present embodiments are not limited thereto. The present embodiments are also applicable to various kinds of semiconductor storage devices including volatile memories and nonvolatile memories. For example, the present embodiments are also applicable to a resistance change memory of the same kind as the MRAM such as a resistive random access memory (ReRAM) or a phase-change random access memory (PCRAM).

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A resistance change memory comprising:
a memory cell array comprising memory cells including magnetic tunnel junction (MTJ) elements;
an error checking and correcting (ECC) circuit which performs an ECC operation to detect an error in data read from the memory cells and correct the error; and
a controller which performs the ECC operation by the ECC circuit at a predetermined period.

2. The resistance change memory according to claim 1, further comprising a temperature sensor which outputs temperature information corresponding to a temperature of the memory cell array,
wherein the controller changes the predetermined period to perform the ECC operation in accordance with the temperature information.

3. The resistance change memory according to claim 2, wherein the temperature sensor outputs first information when the temperature of the memory cell array is a high temperature, and the temperature sensor outputs second information when the temperature is a low temperature lower than the high temperature, and
the controller performs the ECC operation at a first period when receiving the first information, and the controller performs the ECC operation at a second period longer than the first period when receiving the second information.

4. The resistance change memory according to claim 2, wherein the temperature sensor outputs first information when the temperature of the memory cell array is a high temperature, the temperature sensor outputs second information when the temperature is a medium temperature lower than the high temperature, and the temperature sensor outputs third information when the temperature is a low temperature lower than the medium temperature and
the controller performs the ECC operation at a first period when receiving the first information, the controller performs the ECC operation at a second period longer than the first period when receiving the second information, and the controller does not perform the ECC operation when receiving the third information.

5. The resistance change memory according to claim 1, wherein the controller simultaneously performs the ECC operation for banks in the memory cell array in parallel, and each of the banks is a minimum unit including memory cells that are simultaneously accessible in parallel in response to an external read request or write request.

6. The resistance change memory according to claim 1, wherein the resistance change memory comprises a magnetoresistive random access memory (MRAM).

7. A resistance change memory comprising:
a memory cell array comprising memory cells including resistance change elements;
a sense amplifier which reads data stored in the memory cells and which performs a read operation to output read data;
an error checking and correcting (ECC) circuit which performs an ECC operation to detect an error in the read data and correct the error and outputs corrected data;
a write circuit which performs a write operation to write the corrected data into the memory cell array; and
a controller which performs a series of operations including the read operation, the ECC operation, and the write operation at a predetermined period.

8. The resistance change memory according to claim 7, further comprising a temperature sensor which outputs temperature information corresponding to a temperature of the memory cell array,
wherein the controller changes the predetermined period in accordance with the temperature information.

9. The resistance change memory according to claim 8, wherein the temperature sensor outputs first information when the temperature of the memory cell array is a high temperature, and the temperature sensor outputs second information when the temperature is a low temperature lower than the high temperature, and
the controller sets the predetermined period to a first period when receiving the first information, and the controller sets the predetermined period to a second period longer than the first period when receiving the second information.

10. The resistance change memory according to claim 8, wherein the temperature sensor outputs first information when the temperature of the memory cell array is a high temperature, the temperature sensor outputs second information when the temperature is a medium temperature lower than the high temperature, and the temperature sensor outputs third information when the temperature is a low temperature lower than the medium temperature and
the controller sets the predetermined period to a first period when receiving the first information, the controller sets the predetermined period to a second period longer than the first period when receiving the second information, and the controller sets the predetermined period to a third period longer than the second period when receiving the third information.

11. The resistance change memory according to claim 7, wherein the controller simultaneously performs the ECC operation for banks in the memory cell array in parallel, and each of the banks is a minimum unit including memory cells that are simultaneously accessible in parallel in response to an external read request or write request.

12. The resistance change memory according to claim 7, wherein the resistance change memory comprises a magnetoresistive random access memory (MRAM).

13. A resistance change memory comprising:
a memory cell array comprising memory cells including magnetic tunnel junction (MTJ) elements;
an error checking and correcting (ECC) circuit which performs an ECC operation to detect an error in data read from the memory cells and correct the error;
a temperature sensor which outputs temperature information corresponding to a temperature of the memory cell array; and
a controller which performs the ECC operation at a first time interval when the temperature information indicates a first temperature and which performs the ECC operation at a second time interval when the temperature information indicates a second temperature higher than the first temperature.

14. The resistance change memory according to claim 13, wherein the second time interval is shorter than the first time interval.

15. The resistance change memory according to claim 13, wherein the controller simultaneously performs the ECC operation for banks in the memory cell array in parallel, and each of the banks is a minimum unit including memory cells that are simultaneously accessible in parallel in response to an external read request or write request.

16. The resistance change memory according to claim 13, wherein the resistance change memory comprises a magnetoresistive random access memory (MRAM).
